(19) United States
(12) Patent Application Publication
(10) Pub. No.: US 2026/0347628 A1
(43) Pub. Date: Nov. 5, 2026

(54) Surface Treated Nepheline Syenite and Compositions Including the Same

(71) Applicant: Covia Solutions LLC, INDEPENDENCE, OH (US)

(72) Inventors: Richard Eugene Harper, JR., Matthews, NC (US); David Dimitri Kragten, Salisbury, NC (US); Xueping Qiu, Stamford, CT (US); Scott P. Van Remortel, Bakersville, NC (US)

(73) Assignee: Covia Solutions LLC, INDEPENDENCE, OH (US)

(21) Appl. No.: 19/197,200

(22) Filed: May 2, 2025

(51) Int. Cl. C09D 7/62; C08K 9/06; C09D 5/29; C09D 7/40; C09D 167/06; C09D 175/02

(52) U.S. Cl. CPC C09D 7/62; C09D 5/29; C09D 7/69; C09D 167/06; C09D 175/02; C08K 9/06; C08K 2201/005

(57) ABSTRACT

A non-aqueous coating formulation comprising a resinous component, a surface-treated nepheline syenite component; and optionally a non-aqueous solvent. The non-aqueous coating formulation demonstrates improved stability and dispersibility relative to a comparable non-surface treated nepheline syenite component.

### BACKGROUND

Nepheline syenite is a desirable material for a number of applications because it contains no free silica and functions as a filler or extender. In coatings, the nepheline syenite may provide or increase scrub, stain, and/or abrasion resistance, while providing gloss control. However, when incorporated into some compositions such as paint and liquid resins, the nepheline syenite may settle out of the composition over time. Consequently, it is rarely used in industrial topcoats such as polyaspartic topcoats or polyurethane topcoats. Therefore, despite the ability of nepheline syenite to improve scrub and abrasion resistance, as well as lowering the cost of coating formulations, its use in topcoats remains limited.

Therefore, there remains a need for coating compositions including a filler that has improved dispersion and/or reduced settling or caking, while maintaining good abrasion and stain resistance properties, and gloss control in the coating compositions and methods for making the same.

### SUMMARY

In aspects of the present disclosure, a non-aqueous coating formulation is provided. The non-aqueous coating formulation comprises a resinous component, a surface-treated nepheline syenite component, and wherein the non-aqueous coating formulation exhibits a change in viscosity over a period of thirty days that is less than a change in viscosity of an otherwise identical composition including a nepheline syenite component that is not surface treated.

In aspects of the present disclosure, a non-aqueous coating formulation is provided. The non-aqueous coating formulation comprises a resinous component, a surface-treated nepheline syenite component, and optionally a non-aqueous solvent.

In aspects of the present disclosure, a high-solids non-aqueous coating composition is provided. The high-solids non-aqueous coating composition comprises a resinous component comprising a gel coat, and a surface-treated nepheline syenite component.

Additional aspects of the present disclosure include coatings formed from the non-aqueous coating formulations, and the methods of making the surface treated nepheline syenite as well as methods of making the non-aqueous coating formulations disclosed herein.

### BRIEF DESCRIPTION OF THE DRAWINGS

FIG. 1 shows the color shifts of gel coats containing fillers according to Example 3 for 4 weeks.

FIG. 2 shows the color shifts of gel coats containing fillers according to Example 3 for 12 weeks.

FIG. 3 shows the color shifts of gel coats containing fillers according to Example 4 for 2 weeks.

FIG. 4 shows the change in viscosity for the resins containing fillers according to Example 5 over 30 days.

FIG. 5 includes photographs of the resins containing fillers according to Example 5 (and Example 6) showing the lack of settling of the filler at 30 days.

### DETAILED DESCRIPTION

The present disclosure provides non-aqueous coating formulations comprising a resinous component, a surface-treated nepheline syenite component, and optionally a non-aqueous solvent. As such, the coating formulations include non-aqueous solvent-borne compositions, as well as high solids and/or solvent-free compositions, e.g., compositions with a reactive diluent. The non-aqueous coating formulation exhibits a change in viscosity over a period of thirty days that is less than a change in viscosity of an otherwise identical composition including a nepheline syenite component that is not surface treated. Other aspects may include benefits such as blush resistance (low color shift) of the cured coating after exposure to water. Also disclosed are methods for surface treating the nepheline syenite and methods of making the non-aqueous coating formulation.

Unless otherwise indicated, all mesh sizes disclosed herein refer to mesh (U.S.).

Due to variations in feed materials and accuracy of measurement issues, it will be understood that “about” in connection with the concentrations herein means that the above numbers have an accuracy of ±3 wt. %, more typically ±2 wt. %, ±1 wt. %, and even ±0.1 wt. % as understood within the context and tolerances for the particular values.

The non-aqueous coating formulations comprise a resinous component, a surface-treated nepheline syenite, and optionally a non-aqueous solvent. The coating formulations can be one-component or two-component formulations, including those with high solids, those that are solvent-free, those with the optional non-aqueous solvent, and others as are known in the art. In various aspects, the resinous component comprises a polyester resin, an acrylic resin, an alkyd resin, a polyurea resin, a polyurethane resin, an epoxy resin, a vinyl resin, or combinations thereof. However, other resins are contemplated and possible, including any resin known and used in such non-aqueous coating formulations. In some aspects, the resinous component comprises a polyurea resin, which can be, for example, a polyaspartic resin. In some aspects, the resinous component comprises an unsaturated polyester resin. In some aspects, the resinous component is a gel coat form of the resins disclosed herein. The resinous component is included in the non-aqueous coating formulation in an amount of from about 50 wt. % to about 99.5 wt. %, from about 60 wt. % to about 99.5 wt. %, from about 65 wt. % to about 99.5 wt. %, from about 70 wt. % to about 99.5 wt. %, from about 75 wt. % to about 99.5 wt. %, from about 80 wt. % to about 99.5 wt. %, from about 85 wt. % to about 99.5 wt. %, from about 87.5 wt. % to about 99.5 wt. %, from about 90 wt. % to about 99.5 wt. %, from about 92.5 wt. % to about 99.5 wt. %, from about 95 wt. % to about 99.5 wt. %, or from about 97 wt. % to about 99.5 wt. % based on a total weight of the non-aqueous coating formulation, including any and all ranges and subranges therein.

The non-aqueous coating formulation comprises a surface-treated nepheline syenite component. In various aspects, the surface-treated nepheline syenite component comprises nepheline syenite that has been subjected to a surface treatment with one or more functionalized silane(s). The functionalized silane preferably comprises a silane coupling agent. The functionalized silane generally has a formula of (R)(CH₃)ₙSi(X)₍₃₋ₙ₎, where n is the integer 0, 1, or 2; X is a hydrolysable group, and R is an organofunctional group. Nonlimiting examples of hydrolysable groups X include alkoxy such as methoxy, ethoxy, propoxy, acyloxy, halogen, and amine. Nonlimiting examples of the organofunctional group R include an ethylenically unsaturated group such as a (meth)acrylate group or a vinyl group, a phenyl group, and an alkyl group such as a methyl, propyl, isobutyl, or octyl group, including their corresponding halides. As such, the functionalized silane can comprise an ethylenically unsaturated group such as a (meth)acrylate group, a vinyl group, a phenyl group, and/or an alkyl group such as a methyl, propyl, isobutyl, or octyl group. Nonlimiting specific examples of the functionalized silanes include methacryloxypropyltrimethoxysilane, n-octyltriethoxysilane, isobutyltrimethoxysilane, propyltriethoxysilane, methyltriethoxysilane, phenyltriethoxysilane, vinyltrimethoxysilane, vinyltriethoxysilane acryloxymethyltrimethoxysilane, acryloxypropyltrimethoxysilane, methylvinyldimethoxysilane, dimethyldimethoxysilane, diphenyldimethoxysilane, methacrloxymethyltriethoxysilane, methacryloxypropyldimethylethoxysilane, methacryloxypropyltriisopropoxysilane, (3-chloropropyl)-triethoxysilane, (3-chloropropyl)-methyldimethyoxysilane, methacryloxymethyldimethylethoxysilane, or combinations thereof. In one particular example, the nepheline syenite is surface treated with methacryloxypropyltrimethoxysilane and n-octyltriethoxysilane. In another example, the nepheline syenite is surface treated with vinyltrimethoxysilane and n-octyltriethoxysilane. In another example, the nepheline syenite is surface treated with vinyltriethoxysilane and n-octyltriethoxysilane. When more than one silane is used, the relative amounts may vary depending on the particular functionalized silanes used and/or desired properties, which would be apparent to one skilled in the field. In some aspects, the surface treatment may include a diluent, such as any of the non-aqueous solvents disclosed herein to facilitate application to the nepheline syenite, e.g., the organic solvent may be added as a diluent to modify the viscosity and improve applicability surface treatment to the nepheline syenite.

In various aspects, the nepheline syenite has a D50 particle size ranging of from 1 μm to 100 μm. For example, the nepheline syenite may have an D50 particle size of from 1 μm to 100 μm, from 5 μm to 100 μm, from 10 μm to 100 μm, from 25 μm to 100 μm, from 50 μm to 100 μm, from 75 μm to 100 μm, from 1 μm to 75 μm, from 5 μm to 75 μm, from 10 μm to 75 μm, from 25 μm to 75 μm, from 50 μm to 75 μm, from 1 μm to 50 μm, from 5 μm to 50 μm, from 10 μm to 50 μm, from 25 μm to 50 μm, from 1 μm to 25 μm, from 5 μm to 25 μm, or from 10 μm to 25 μm, including any and all ranges and subranges therein. The nepheline syenite may additionally or alternatively be characterized by a maximum particle size. In various aspects, the nepheline syenite has a maximum particle size of about 1 mm or less, about 0.5 mm or less, or even about 0.25 mm or less. The nepheline syenite may have a maximum particle size of less than 90 μm, less than 75 μm, less than 50 μm, less than 25 μm, less than 20 μm, less than 15 μm, or even less than 10 μm. Suitable granular nepheline syenite can include, by way of example and not limitation, MINEX® 4, MINEX® 7, MINEX® 10, or MINEX® 12 available from Covia Solutions LLC.

This disclosure also includes methods of surface treating the nepheline syenite. The surface treatment can be applied to the nepheline syenite by a dry process, or a wet process followed by drying, according to conventional methods. In the dry process, the surface treatment is sprayed onto or mixed with a well-agitated nepheline syenite. For maximum efficiency, uniform surface treatment dispersion is essential, and this is made possible by the high shear rates provided by the mixing equipment. Examples of manufacturers of such mixing and processing equipment include Loedige, Littleford Day, Hosokawa Alpine, and Thyssen Henschel. The most important commercial surface treatment coating processes contemplated herein are continuous and have high through-put rates. Control of surface treatment addition, dwell time, and exact temperature control within the system are essential. An elevated temperature is required for a complete reaction to occur between the surface treatment and the nepheline syenite. In practice, however, an excessively high temperature may lead to a loss of surface treatment through evaporation. The wet process is usually limited to quickly water-soluble surface treatments and waterborne surface treatment systems. In rare cases, surface treatments in emulsion form can also be applied. In this process, the nepheline syenite is mixed with a carrier in a slurry form, the surface treatment is mixed with water, mixtures of alcohol and water, or a variety of polar and non-polar solvents. Typically, low concentrations of the surface treatment (see below) are dissolved by hydrolysis. The surface treatment solution or emulsion is applied by spraying or it can be dripped in. After the treatment, any water, solvents, and/or reaction by-products are removed by dehydration and drying.

The surface treatment can be applied to the nepheline syenite at amounts ranging from about 0.05 weight (wt.) % to about 5 wt. %, from about 0.075 wt. % to about 5 wt. %, from about 0.09 wt. % to about 5 wt. %, from about 0.1 wt. % to about 5 wt. %, from about 0.15 wt. % to about 5 wt. %, from about 0.2 wt. % to about 5 wt. %, from about 0.25 wt. % to about 5 wt. %, from about 0.3 wt. % to about 5 wt. %, from about 0.35 wt. % to about 5 wt. %, from about 0.4 wt. % to about 5 wt. %, from about 0.45 wt. % to about 5 wt. %, from about 0.5 wt. % to about 5 wt. %, from about 0.75 wt. % to about 5 wt. %, or from about 1 wt. % to about 5 wt. %, 0.05 wt. % to about 2.5 wt. %, from about 0.075 wt. % to about 2.5 wt. %, from about 0.09 wt. % to about 2.5 wt. %, from about 0.1 wt. % to about 2.5 wt. %, from about 0.15 wt. % to about 2.5 wt. %, from about 0.2 wt. % to about 2.5 wt. %, from about 0.25 wt. % to about 2.5 wt. %, from about 0.3 wt. % to about 2.5 wt. %, from about 0.35 wt. % to about 2.5 wt. %, from about 0.4 wt. % to about 2.5 wt. %, from about 0.45 wt. % to about 2.5 wt. %, from about 0.5 wt. % to about 2.5 wt. %, from about 0.75 wt. % to about 2.5 wt. %, or from about 1 wt. % to about 2.5 wt. %, 0.05 wt. % to about 1.5 wt. %, from about 0.075 wt. % to about 1.5 wt. %, from about 0.09 wt. % to about 1.5 wt. %, from about 0.1 wt. % to about 1.5 wt. %, from about 0.15 wt. % to about 1.5 wt. %, from about 0.2 wt. % to about 1.5 wt. %, from about 0.25 wt. % to about 1.5 wt. %, from about 0.3 wt. % to about 1.5 wt. %, from about 0.35 wt. % to about 1.5 wt. %, from about 0.4 wt. % to about 1.5 wt. %, from about 0.45 wt. % to about 1.5 wt. %, from about 0.5 wt. % to about 1.5 wt. %, or from about 0.75 wt. % to about 1.5 wt. %, including any and all ranges and subranges therein, based on the total weight of the surface-treated nepheline syenite component.

The optimum treatment range depends on the type of surface treatment used and the particle size of the nepheline syenite used. The goal is to use as little surface treatment as possible to form a mono-layer of surface treatment on the surface of the nepheline syenite, while ensuring complete coverage. For example, for 1:1 silane mixture of vinyltrimethoxysilane and n-octyltriethoxysilane having an average molecular weight of 185 and 0.25 nm² per molecule, the required silane weight percent for a monolayer of treated nepheline syenite powder of a specific surface areas of 4.9 m²/g, 3.6 m²/g, and 2.2 m²/g, is 0.6 wt. %, 0.5 wt. % and 0.3 wt. %, respectively. There is a minimal loss during the treatment process. When the loss is considered, higher amount of silane must be used, for example, with 1:1 silane mixture of vinyltrimethoxysilane and n-octyltriethoxysilane, one may need to use a minimum 0.5 wt. % for nepheline syenite with a median particle size of 7.6 μm (MINEX® 4), 0.7 wt. % for a median particle size of 4.3 μm (MINEX® 7), 0.85 wt. % for a median particle size of 2.4 μm (MINEX® 10), etc. The amount of silane needed may vary depending on other conditions, such as the temperature of the dry process, which can be readily determined by one of skill in this field.

The surface-treated nepheline syenite component is included in the non-aqueous coating formulation in an amount of from greater than 0 wt. % to about 50 wt. %, based on the total weight of the non-aqueous coating formulation. For example, the surface-treated nepheline syenite component may be included in the non-aqueous coating formulation in an amount of from about 0.5 wt. % to about 50 wt. %, from about 1 wt. % to about 50 wt. %, from about 2.5 wt. % to about 50 wt. %, from about 5 wt. % to about 50 wt. %, from about 7.5 wt. % to about 50 wt. %, from about 10 wt. % to about 50 wt. %, from about 12.5 wt. % to about 50 wt. %, from about 15 wt. % to about 50 wt. %, about 20 wt. % to about 50 wt. %, from about 25 wt. % to about 50 wt. %, from about 30 wt. % to about 50 wt. %, from about 40 wt. % to about 50 wt. %, about 0.5 wt. % to about 40 wt. %, from about 1 wt. % to about 40 wt. %, from about 2.5 wt. % to about 40 wt. %, from about 5 wt. % to about 40 wt. %, from about 7.5 wt. % to about 40 wt. %, from about 10 wt. % to about 40 wt. %, from about 12.5 wt. % to about 40 wt. %, from about 15 wt. % to about 40 wt. %, about 20 wt. % to about 40 wt. %, from about 25 wt. % to about 40 wt. %, from about 30 wt. % to about 40 wt. %, about 0.5 wt. % to about 30 wt. %, from about 1 wt. % to about 30 wt. %, from about 2.5 wt. % to about 30 wt. %, from about 5 wt. % to about 30 wt. %, from about 7.5 wt. % to about 30 wt. %, from about 10 wt. % to about 30 wt. %, from about 12.5 wt. % to about 30 wt. %, from about 15 wt. % to about 30 wt. %, from about 20 wt. % to about 30 wt. %, from about 0.5 wt. % to about 20 wt. %, from about 1 wt. % to about 20 wt. %, from about 2.5 wt. % to about 20 wt. %, from about 5 wt. % to about 20 wt. %, from about 7.5 wt. % to about 20 wt. %, from about 10 wt. % to about 20 wt. %, from about 12.5 wt. % to about 20 wt. %, from about 15 wt. % to about 20 wt. %, from about 0.5 wt. % to about 15 wt. %, from about 1 wt. % to about 15 wt. %, from about 2.5 wt. % to about 15 wt. %, from about 5 wt. % to about 15 wt. %, from about 7.5 wt. % to about 15 wt. %, from about 10 wt. % to about 15 wt. %, from about 12.5 wt. % to about 15 wt. %, from about 0.5 wt. % to about 12 wt. %, from about 1 wt. % to about 12 wt. %, from about 2.5 wt. % to about 12 wt. %, from about 5 wt. % to about 12 wt. %, from about 7.5 wt. % to about 12 wt. %, from about 10 wt. % to about 12 wt. %, from about 0.5 wt. % to about 10 wt. %, from about 1 wt. % to about 10 wt. %, from about 2.5 wt. % to about 10 wt. %, from about 5 wt. % to about 10 wt. %, or from about 7.5 wt. % to about 10 wt. %, including any and all ranges and subranges therein.

The non-aqueous coating formulations may further include one or more moisture scavenger, plasticizer, defoamer, flow and/or leveling additive, catalyst, surface-active stabilizer, pigment, dye, UV-stabilizer, hindered-amine light stabilizer, antioxidant, dispersant, flame-retardant, and the like. Such additional components may be included in the non-aqueous coating formulation in amounts generally accepted and used in the art.

The non-aqueous coating formulations may further include an optional non-aqueous solvent. The non-aqueous solvent may include, by way of example and not limitation, an organic solvent that is typically used in a non-aqueous coating formulation by those skilled in the art. Examples of suitable organic solvents include but are not limited to aliphatic hydrocarbons such as hexane and heptane; aromatic hydrocarbons such as benzene, toluene, and xylene; alcohols such as isopropanol; ethers such as a propylene glycol methyl ether (DOWANOL™ PM glycol ether) and diethyl ether; esters such as propylene glycol methyl ether acetate (PM acetate) and butyl acetate; ketones such as methyl n-amyl ketone and methyl ethyl ketone (MEK); and combinations thereof. The solvent is included in the non-aqueous coating formulation in an amount of from 0 wt. % to about 60 wt. %, including from about 0.5 wt. % to about 55 wt. %, including from about 1 wt. % to about 50 wt. %, including from about 1 wt. % to about 30 wt. %, including from about 1 wt. % to about 25 wt. %, including from about 1 wt. % to about 20 wt. %, including from about 1 wt. % to about 15 wt. %, including from about 1 wt. % to about 10 wt. %, including from about 1 wt. % to about 5 wt. %, including from about 1 wt. % to about 3 wt. %, or including from about 1 wt. % to about 2 wt. %, based on a total weight of the non-aqueous coating formulation, including any and all ranges and subranges therein.

The present disclosure also includes methods of making the non-aqueous coating formulation. In various aspects, methods include mixing the resinous component, the surface-treated nepheline syenite component, and any additional components together with an optional non-aqueous solvent to form the non-aqueous coating formulation according to conventional methods. When applied to a substrate, the formulation will dry, cure, and/or desolvate to form a coating.

The surface-treated nepheline syenite powder described herein may be used in any of a number of applications, such as fillers, extenders, and the like in paints, coatings, plastics, paper, adhesives, puttys, caulks, sealants, and other construction or engineered materials including engineered stone.

### EXAMPLES

The following examples are included for the purposes of illustration and do not limit the general inventive concepts described herein.

### Example 1: Preparation of Surface Treated Nepheline Syenite

Samples of surface treated nepheline syenite powder (commercially available from Covia Solutions LLC as MINEX® 12) having a median particle size of 1.5 μm with the typical compositional profile (based on wt. %) shown in Table 1 below were prepared according to the following process:
a) Nepheline syenite mineral powder is added to a laboratory mixer.
b) The mixer is turned on to 1000 rpm.
c) About half of the surface treatment amount shown in Tables 2 and 3 are added to the mixer for the respective sample and mixed for 5 minutes.
d) The mixer is turned off to wipe down the interior walls and lid.
e) The remaining half of the surface treatment is added to the mixer and mixed for 5 minutes.
f) The surface treated nepheline syenite powder sample is removed from the mixer and dried in a 90 °C oven for 60 minutes.

TABLE 1
Nepheline Syenite Compositional Profile (wt. %)

| | |
|---|---|
| Silicon Dioxide (SiO₂) | 60.20 |
| Iron Oxide (Fe₂O₃) | 0.08 |
| Aluminum Oxide (Al₂O₃) | 23.60 |
| Calcium Oxide (CaO) | 0.35 |
| Magnesium Oxide (MgO) | 0.02 |
| Potassium Oxide (K₂O) | 4.80 |
| Sodium Oxide (Na₂O) | 10.50 |

TABLE 2
Surface Treatments

| | | | surface | surface | | | |
|---|---|---|---|---|---|---|---|
| Surface | | Mx12 | treatment | treatment | solvent | | |
| Treatment | Purpose | (g) | 1 (g) | 2 (g) | (g) | solvent | surface treatment |
| Silanes ⁽¹⁾ | | | | | | | |
| methacrylate | coupling with | 100 | 1 | | 3 | EtOH | Methacryloxy- |
| silane | resin | | | | | | propyltrimethoxy- |
| | | | | | | | silane (Sigma) |
| vinyl silane | coupling with | 100 | 1 | | 3 | EtOH | Vinyltriethoxy- |
| | resin | | | | | | silane (Aldrich) |
| octyl | hydrophobic | 100 | 0.5 | 0.5 | 3 | EtOH | n-Octyltriethoxy- |
| methacrylate | surface | | | | | | silane (Dow |
| silane | treatment + | | | | | | Corning) + |
| | coupling with | | | | | | methacryloxy- |
| | resin | | | | | | propyltrimethoxy- |
| | | | | | | | silane |
| octyl + vinyl | hydrophobic | 100 | 0.5 | 0.5 | 3 | EtOH | Octyltriethoxy- |
| silane | surface | | | | | | silane + |
| | treatment + | | | | | | vinyltriethoxy- |
| | coupling with | | | | | | silane |
| | resin | | | | | | |
| SMA | | | | | | | |
| polymer ⁽²⁾ | | | | | | | |
| SMA A | coupling, | 100 | 3 | | 10 | MEK | styrene maleic |
| | dispersion | | | | | | anhydride |
| | | | | | | | polymer (SMA |
| | | | | | | | 1000, Sartomer) |
| SMA B | coupling, | 100 | 3 | | 10 | MEK | styrene maleic |
| | dispersion | | | | | | anhydride |
| | | | | | | | polymer (SMA |
| | | | | | | | 3000, Sartomer) |
| Titanates ⁽²⁾ | | | | | | | |
| titanate A | coupling, | 100 | 1 | | 10 | MEK | titanate coupling |
| | dispersion | | | | | | agent (Ken-React |
| | | | | | | | CAPOW KR TTS/H, |
| | | | | | | | Kenrich) |
| titanate B | coupling, | 100 | 1 | | 10 | MEK | titanate coupling |
| | dispersion | | | | | | agent (Ken-React |
| | | | | | | | CAPOW L 38/H, |
| | | | | | | | Kenrich) |
| Other | | | | | | | |
| stearic acid ⁽²⁾ | repeat first | 100 | 3 | | 10 | MEK | |
| | round | | | | | | stearic acid (3 |
| | | | | | | | wt %, Sigma) |
| Control | | | | | | | |
| MINEX 12 | | | | | | | Nepheline syenite |
| | | | | | | | without surface |
| | | | | | | | treatment |

⁽¹⁾ Applied at about 1 wt % by bulk deposition technique: 25 wt % silane is dissolved in EtOH and added slowly with a transfer pipet while blending with a Waring blender.
⁽²⁾ Applied in two steps: Minex and the solid surface treatment are blended in the Waring blender first, followed by addition of the MEK plasticizer and additional blending.

TABLE 3
Surface Treatments

| | Surface Treatment Level |
|---|---|
| Filler Combinations | (%) |
| Minex 12 | N/A |
| 50% Octyl Silane + 50% Vinyl Silane | 1 |
| MINEX 12 | |
| 50% Octyl Silane + 50% Vinyl Silane | 0.5 |
| MINEX 12 | |
| Amino Silane MINEX 12 | 1 |
| Amino Silane MINEX 12 | 0.5 |
| Vinyl Silane MINEX 12 | 1 |
| Vinyl Silane MINEX 12 | 0.5 |
| Methacrylate Silane MINEX 12 | 1 |
| Methacrylate Silane MINEX 12 | 0.5 |
| Titanate Kr55 MINEX 12 | 0.5 |
| Titanate Lica 12 MINEX 12 | 0.5 |
| Titanate Lica 38 MINEX 12 | 0.5 |
| Talc/MINEX 12 Blend 50:50 | N/A |
| Talc/MINEX 12 Blend 20:80 | N/A |
| 20% Octyl Silane + 80% Vinyl Silane | 0.5 |
| MINEX 12 | |

The octyl silanes and the vinyl silanes in Table 3 are the same as those used in Table 2.

### Example 2: Preparation of Gel Coat Formulation and Test Strips

Respective samples made according to Tables 3 and 4 from Example 1 were added as a filler to a high-solids unsaturated polyester resin gel coat composition in the relative amounts shown in Table 4 below and dispersed by standard paint mixer with Cowles blade at low speed. The samples were successively filtered with a fine paint filter and allowed to sit overnight to eliminate bubbles.

TABLE 4
Gel coat formulation

| Component | Wt. % |
|---|---|
| Unsaturated polyester resin (*) | 85 |
| Filler | 15 |

(*) The resin is high solids, with a typical composition of 50-95% polymer and 5-50% reactive styrene monomer. In addition, 2 wt % catalyst (e.g., Norox MEKP), promotor (e.g., cobalt octoate), and up to 25 wt % of pigments (organic or inorganic) are added. The typical HAP (Hazardous Air Pollutant) content is below 35%.

Self-supported gel coat test strips were prepared on a glass substrate. First, the glass substrate was coated with a thin layer of carnauba wax (Turtle Wax). The gel coat formulation with curing initiator was dispersed for 15 minutes with a standard paint mixer (e.g., Premier Mill) with Cowles blade at low speed. The coatings were applied to the glass panel with a 20-mil wet thickness Bird drawdown bar and cured for 15 minutes at room temperature. The coatings were scored with a utility knife in 0.5-inch strips. After fully curing in an oven at 130 °C overnight, the gel coats were removed from the glass slide and broken into individual test strips. Each test strip is tested independently.

### Example 3: Water Immersion Screening Test (to Evaluate Color Shift/Blush Resistance)

Six test gel coated strips from Example 2 prepared with each sample from Table 2 above were submerged in deionized water in a Qopak wide-mouth glass jar and placed in an oven at 65 °C to demonstrate color shift by exposure to water. Note that the six strips are made from one drawdown sample; however, each strip is tested independently. Care was taken to retain the water level sufficient to keep the strips submerged during the entire test. One test strip was removed from the jar at preset times of 1, 2, 3, 4, 8, and 12 weeks and air dried overnight.

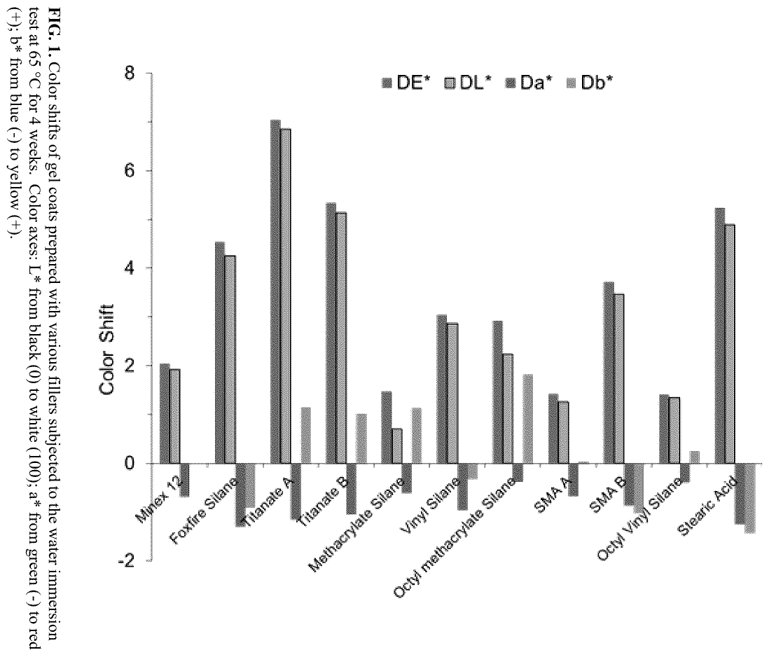

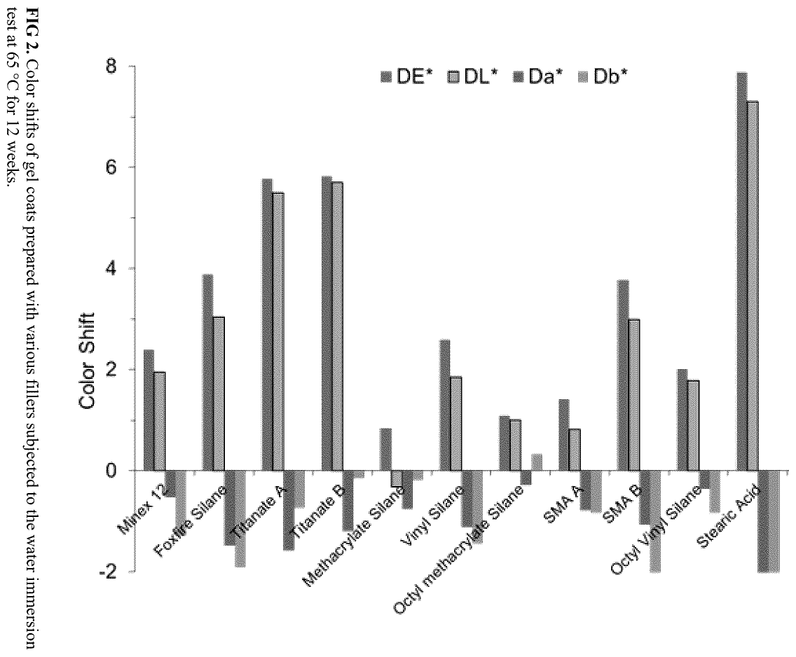

To evaluate water immersion stability, color shift of each of the six water-exposed test gel coated strips was determined by comparison to gel coated strips that had not been exposed to water. Measurements were performed with a Gretag MacBeth Colorimeter I5 spectrophotometer utilizing a D65 illuminant using the small aperture viewport (SAV). Since these systems have a high gloss, measurements were performed with exclusion of specular reflectance. The color shift results are shown in FIG. 1 after 4 weeks and in FIG. 2 after 12 weeks. As seen in FIGS. 1 and 2, of all of the samples, the gel coats having the nepheline syenite coated with methacrylate silane and the octyl silane/vinyl silane showed the lowest color shift after 4 weeks, and the methacrylate silane, the octyl silane/methacrylate silane, and octyl silane/vinyl silane after 12 weeks.

### Example 4: 85 °C Water Test (to Evaluate Color Shift/Blush Resistance)

For the boiling water test at 85 °C, gel coat samples were prepared similarly to the test strips used in Example 2. The gel coat test panel was prepared as follows. A 4×6-inch glass plate was prepared by waxing with a thin layer of carnauba wax. The gel coat test formula from Example 2 prepared with each filler sample from Table 3 was mixed with curing initiator while stirring by hand. The resulting mixture was sprayed on the glass plate with a gelcoat cup gun to obtain a wet thickness of approximately 20 mils. The coating was allowed to be cured in air for approximately 3-4 hours until it was only slightly tacky. A commercial barrier coating was applied by spraying to obtain a wet thickness of about 15 mils. The coating was allowed to be cured in air for approximately 3-4 hours until it was only slightly tacky. A fiberglass-resin backing was applied as three layers of commercial 1.5 oz chopped strand mat in commercial laminating resin cured with hardener, using a fiberglass roller. The gel coat panels were allowed to cure for two hours and placed in a 150 °F oven for 16 hours to cure fully. After removing from the oven, the panels were removed from the glass plates. Three panels were prepared for each test case. Test panels were tested by placing a glass cylinder on a test square of the sample. The glass cylinder had an inside diameter of 1.25″ and was sealed to the gel coat test panel with vacuum grease. The cylinder was filled with deionized water, covered with a small round glass plate, and placed in the oven at 85 °C. The samples were pulled from the oven every week; the water was emptied; and the test square was allowed to dry for at least 4 hours before checking with the color instrument. Based on color and blister results, the test was continued for another week or discontinued.

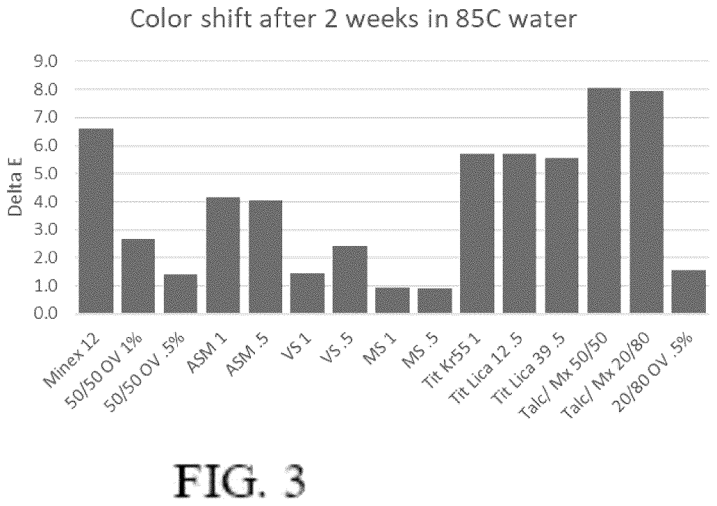

The gel coats strips were measured for color on a Gretag Macbeth Color i5 colorimeter with specular reflection contribution both included and excluded. Color changes are shown with specular reflection excluded, since this mode is considered to better represent the actual color for high-gloss coatings such as these. The color shift results are shown in FIG. 3. FIG. 3 shows the lowest color shift for those treated with the octyl silane/vinyl silane combination.

### Example 5: Change in Viscosity Over Time

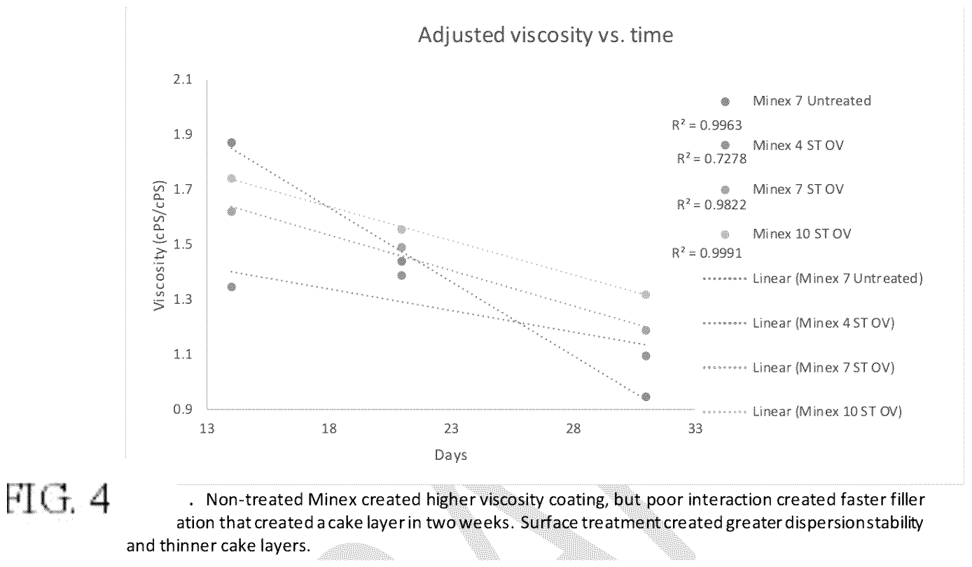

Nepheline syenite powders with median particle sizes varying from 2.4 μm (MINEX® 10), 4.3 μm (MINEX® 7), and 7.6 μm (MINEX® 4) and with the typical compositional profile (based on wt. %) shown in Table 1, were surface treated with a mixture of 0.5 wt % vinyltrimethylethoxysilane and 0.5 wt % n-octyltriethoxysilane and dried. The surface treated nepheline syenite powder samples were then added as a filler in part A (amine functional resin) of a two-part polyaspartic coating composition (ETERASP 9703) in the relative amounts shown in Table 5 below. The resulting coating formulation was stored for a period of 30 days, and the viscosity was tested periodically over this time using a LV Brookfield viscometer. The results are shown in FIG. 4.

TABLE 5
Coating formulation

| Component | Wt. % |
|---|---|
| ETERASP 9703 resin | 80 |
| Filler | 20 |

As shown in FIG. 4, the coating formulations that contained untreated nepheline syenite had a much greater decrease in viscosity over this period than the coating formulations that contained nepheline syenite which had been surface treated with the mixture of vinyltrimethylethoxysilane and n-octyltriethoxysilane.

### Example 6: Dispersion Stability

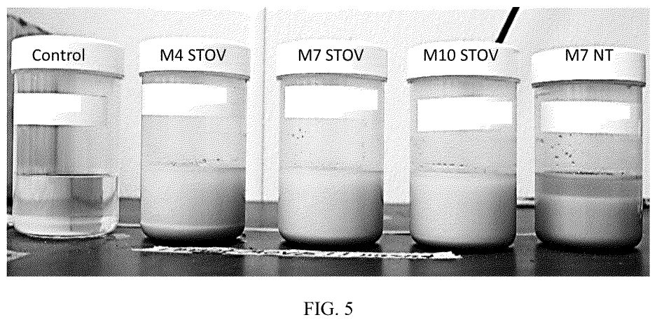

The resins prepared for use in Example 5 were observed for filler flocculation, i.e., filler solids separating from the amine-functional resin. FIG. 5 shows photographs of the resins at 30 days, with “Control” showing the resin without any filler, “M4 STOV”, “M7 STOV”, and “M10 STOV” referring to the different grades of nepheline syenite surface treated with the vinyltrimethylethoxysilane and n-octyltriethoxysilane, and “M7 NT” referring to the MINEX 7 powder without surface treatment. As shown in FIG. 5, the M7 NT settled out of the resin and formed a thicker layer of filler at the bottom, while the ST treated version has a thinner layer of filler at the bottom.

Although only a few aspects of this invention have been described above, it should be appreciated that many modifications can be made without departing from the spirit and scope of the invention. All such modifications are intended to be included within this invention, which is to be limited only by the following claims.

1. A non-aqueous coating formulation comprising:
a resinous component;
a surface-treated nepheline syenite component; and
wherein the non-aqueous coating formulation exhibits a change in viscosity over a period of thirty days that is less than a change in viscosity of an otherwise identical composition including a nepheline syenite component that is not surface treated.

2. The non-aqueous coating formulation of claim 1, wherein the surface-treated nepheline syenite component comprises nepheline syenite that has been subjected to a surface treatment with a functionalized silane.

3. The non-aqueous coating formulation of claim 2, wherein the functionalized silane comprises one or more of a (meth)acrylate group, a vinyl group, a phenyl group, and/or an alkyl group.

4. The non-aqueous coating formulation of claim 2, wherein the nepheline syenite has an D50 particle size of from 1 μm to 100 μm.

5. The non-aqueous coating formulation of claim 4, wherein the nepheline syenite has an D50 particle size of from 5 μm to 50 μm.

6. The non-aqueous coating formulation of claim 1, wherein the surface-treated nepheline syenite component is present in the non-aqueous coating formulation in an amount of from 0.5 wt. % to about 30 wt. %, based on a total weight in the non-aqueous coating composition.

7. The non-aqueous coating formulation of claim 1, wherein the coating formulation comprises a two-component coating composition.

8. The non-aqueous coating formulation of claim 1, wherein the resinous component comprises a polyester resin, a polyurea resin, a polyurethane resin, or an epoxy resin.

9. The non-aqueous coating formulation of claim 8, wherein the resinous component comprises a polyurea resin.

10. The non-aqueous coating formulation of claim 9, wherein the polyurea resin comprises a polyaspartic resin.

11. A non-aqueous coating formulation comprising:
a resinous component;
a surface-treated nepheline syenite component; and
optionally a non-aqueous solvent.

12. The non-aqueous coating formulation of claim 11, wherein the surface-treated nepheline syenite component comprises nepheline syenite that has been subjected to a surface treatment with a functionalized silane.

13. The non-aqueous coating formulation of claim 12, wherein the functionalized silane comprises one or more of a (meth)acrylate group, a vinyl group, a phenyl group, and/or an alkyl group.

14. A coating formed from the non-aqueous coating formulation of claim 11.

15. A coating formed from the non-aqueous coating formulation of claim 1.

16. A high-solids non-aqueous coating composition comprising:
a resinous component comprising a gel coat;
and a surface-treated nepheline syenite component.

17. The high-solids non-aqueous coating composition of claim 16, wherein a coating formed from the coating composition exhibits a lower color shift when exposed to water over time than the color shift exhibited by an otherwise identical composition including a nepheline syenite component that is not surface treated.

18. The high-solids non-aqueous coating composition of claim 16, wherein the gel coat comprises an unsaturated polyester resin.
